(19) United States
(12) Patent Application Publication
(10) Pub. No.: US 2014/0207894 A1
(43) Pub. Date: Jul. 24, 2014

(54) METHOD AND APPARATUS FOR IMPROVED LOADING OF WEB-PAGES

(71) Applicant: Thomson Licensing, Issy de Moulineaux (FR)

(72) Inventor: Casimir Johan CRAWLEY, Carmel, IN (US)

(21) Appl. No.: 14/100,472

(22) Filed: Dec. 9, 2013

Related U.S. Application Data
(60) Provisional application No. 61/735,627, filed on Dec. 11, 2012.

(51) Int. Cl. H04L 12/24

(52) U.S. Cl. CPC H04L 41/082
USPC 709/208; 709/221

(57) ABSTRACT

A method and apparatus for updating software, usually a web browser, associated with customer premises equipment (CPE), includes sending a request to resources external to the CPE for update data to update the software, decoupling the

CPE from the external resources so that the software can be updated without interfering with other functions of the CPE during updating of the software, and updating the software as the CPE is decoupled from the external resources and recoupling the CPE to the external resources after updating of the software is completed.

### RELATED APPLICATIONS

This invention claims the benefit of U.S. Provisional Patent Application Ser. No. 61/735,627, filed Dec. 11, 2012, entitled METHOD AND APPARATUS FOR IMPROVED LOADING OF WEB-PAGES, the teachings of which are specifically set forth herein by reference, and is related to U.S. Utility patent application Ser. No. 13/693,288, filed on Dec. 4, 2012, entitled MECHANISM TO BLOCK WEB SITES USING RETURN TRAFFIC, the teachings of which are also specifically set forth herein by reference.

### FIELD OF THE INVENTION

The present invention relates to customer premise equipment (CPE) which allows users to browse the worldwide web. More specifically, the present invention relates to CPE which allows for instantaneous web updates to improve user experience, as well as improving the Quality of Service (QoS) of the user's experience and the performance of the CPE.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Typically a router connects like and unlike networks such as WANs, MANs, LANs etc. That is, typically, a router is an interface between networks. Typically, a gateway provides an entry or exit into/out of a communications network. The terms router and gateway are used interchangeably herein. A home gateway is simply a gateway device that is used in a home/residential environment. A home gateway as used herein includes the functionality of both a router and a gateway and is used to connect the home network to networks outside the home such as the Internet or cable service provider or satellite provider or other networks provided by a communications provider.

Most CPE contains an http server supporting system configuration requests using a web browser. Many CPE system configuration requests are time-consuming operations resulting in excessive web browser update times and subsequent user dissatisfaction. This problem is particularly acute in Broadcom (BCM) DSL middleware that uses one global lock for managing CPE Memory Database Model (MDM) access. Multiple clients simultaneously access BCM's MDM middleware resulting in protracted response times.

### SUMMARY OF THE INVENTION

The present invention provides methods and apparatus for decoupling the CPE system configuration web browser request from the actual CPE operation, thereby allowing instantaneous web browser updates and improving the user experience. The inventive methods and apparatus provide request and acknowledgment actions to prevent race conditions between a web browser and CPE operations.

Preferably, the invention is a method and CPE for updating software associated with CPE, comprising sending a request to resources external to the CPE for update data to update the software, decoupling the CPE from the external resources so that the software can be updated without interfering with other functions of the CPE during updating of the software, and updating the software as the CPE is decoupled from the external resources and recoupling the CPE to the external resources after updating of the software is completed.

The invention will be best understood by reading the following detailed description of the preferred embodiments thereof in conjunction with the drawings which are first described briefly below.

### BRIEF DESCRIPTION OF THE DRAWINGS

The drawings include the following figures briefly described below:

FIG. 1 illustrates a system for communicating between a home and the internet, shown both WAN (internet) and LAN connection through a gateway device in accordance with the principles of the present invention.

FIG. 2 is a block diagram of an exemplary gateway device in accordance with the principles of the present invention.

FIG. 3 is a flowchart of an exemplary implementation of a preferred method of QoS activation wherein the CPE is decoupled from the browser during browser update in accordance with the principles of the present invention.

### DETAILED DESCRIPTION OF THE PREFERRED EMBODIMENTS

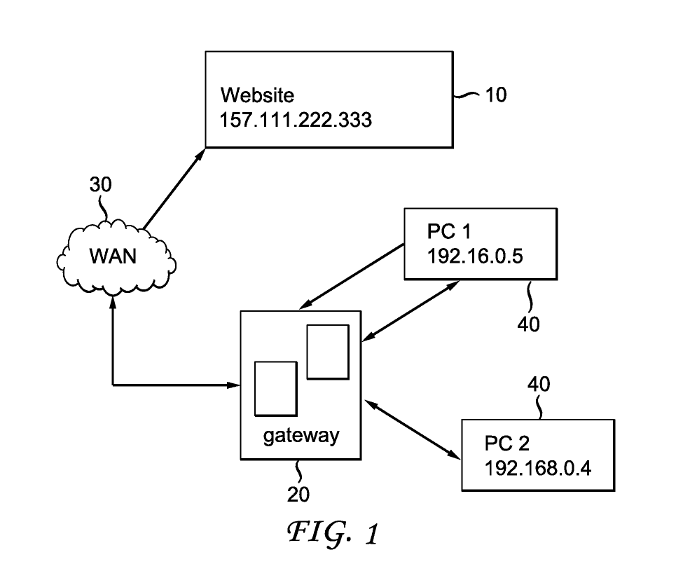

FIG. 1 illustrates a system for communicating between a home and the internet, shown both WAN (internet) and LAN connection through a gateway device in accordance with the principles of the present invention. In FIG. 1 a website, shown at 10, can be contacted by a gateway 20, sometimes called the CPE throughout this text, which communicates through the internet so that a user of the CPE 20 can contact the various websites 10 for downloads, browsing and the like. As will be appreciated by those with skill in the art, the CPE 20 may communicate with the internet through a WAN (or LAN as the terms are used interchangeably herein) shown at 30 so that the home network, in which the CPE 20 is normally placed, may efficiently function to provide access to the users of the home network.

As will be further appreciated, the CPE 20 receives unique IP addresses for the website 10 from the various computers 40 (or other devices in the home network), which themselves are assigned internal IP addresses so that the CPE can manage the home network and the communications throughout. Any number of computers 40 or other devices may reside within the home network and each are thereby assigned IP addresses. Each of the computers 40 will periodically require simultaneous access to middleware associated with the CPE 20, which results in the protracted response times experienced for web browser updates as noted above. This problem is a natural consequence of CPE system configurations that are time-consuming operations resulting in the user dissatisfaction also previously noted.

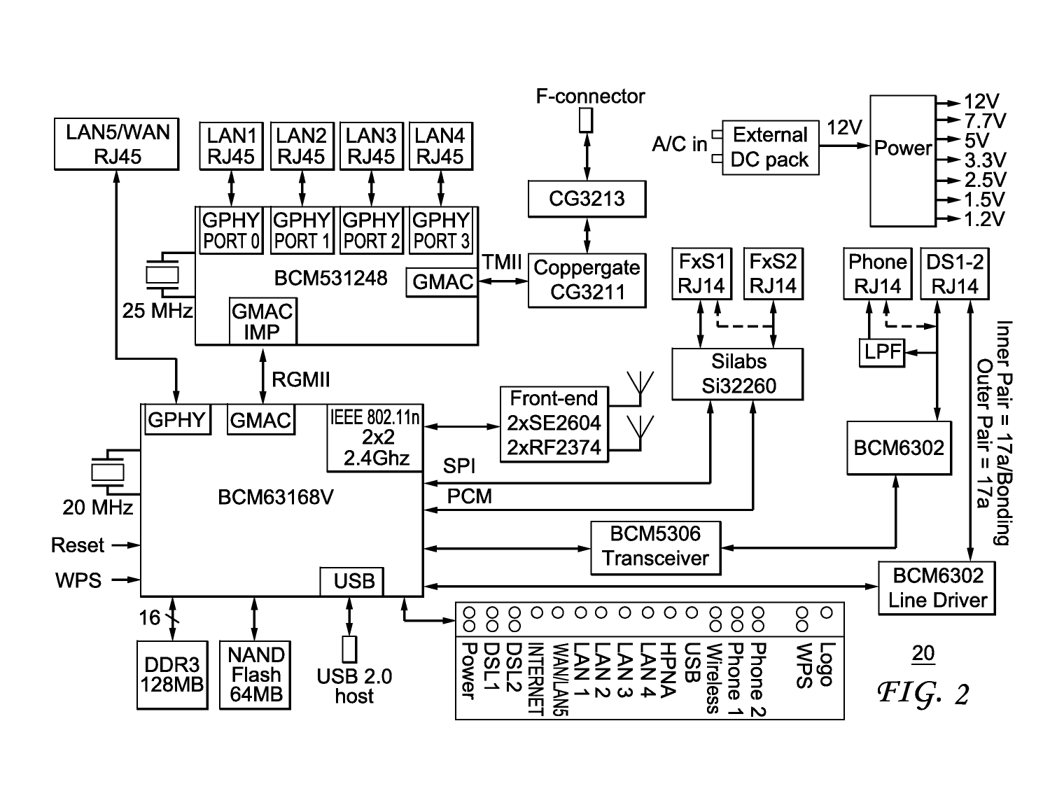

FIG. 2 is a block diagram of an exemplary gateway device 20 in accordance to the principles of the present invention. The main controller is the block labeled BCM63168V. That is, the present invention may be implemented as a program executable on processor/controller BCM6318V. An alternative implementation may be implementation on an application specific integrated circuit (ASIC) or on a field programmable gate array (FPGA) or an equivalent device. The BCM63168V integrated circuit (IC) will receive and process all data traffic from the LAN side and the WAN side and would include any “blocks” associated with incoming LAN traffic (going out to internet) and then also includes the new “blocks” associated with incoming WAN traffic (interception before being transmitted to LAN device).

In FIG. 2 the home gateway 20 includes a front-end for wireless communications and a transceiver (BCM6306) for wired line communications. All reception and transmission signals pass through either the front-end or the transceiver. That is, the means for receiving a requests for access to websites from a user is via either the front-end or the transceiver. The means for determining if the request includes a first domain name is within the controller (BCM63168V) and may be in software (a program) executed on said controller. The means for transmitting the request if the request does not include the first domain name is either the front-end or the transceiver. The means for receiving return traffic in response to the transmitted request is either the front-end or the transceiver. The means for determining if a second domain name in the return traffic matches the first domain name is within the controller (BCM63168V) and may be in software (a program) executed on said controller. The means for allowing access to the website if the first domain name and the second domain name match is within the controller (BCM63168V) and may be in software (a program) executed on said controller. The means for discarding the return traffic if the access is blocked is within the controller (BCM63168V) and may be in software (a program) executed on said controller. The means for determining, based on the first domain name, if the website is blocked is within the controller (BCM63168V) and may be in software (a program) executed on said controller. The means for transmitting the request, if the website in the request is determined not to be blocked, is either the front-end or the transceiver. The means for receiving return traffic in response to the transmitted request is either the front-end or the transceiver. The means for forwarding the return traffic to the user is either the front-end or the transceiver. The means for transmitting a message to the user that access to the requested website is blocked is either the front-end or the transceiver.

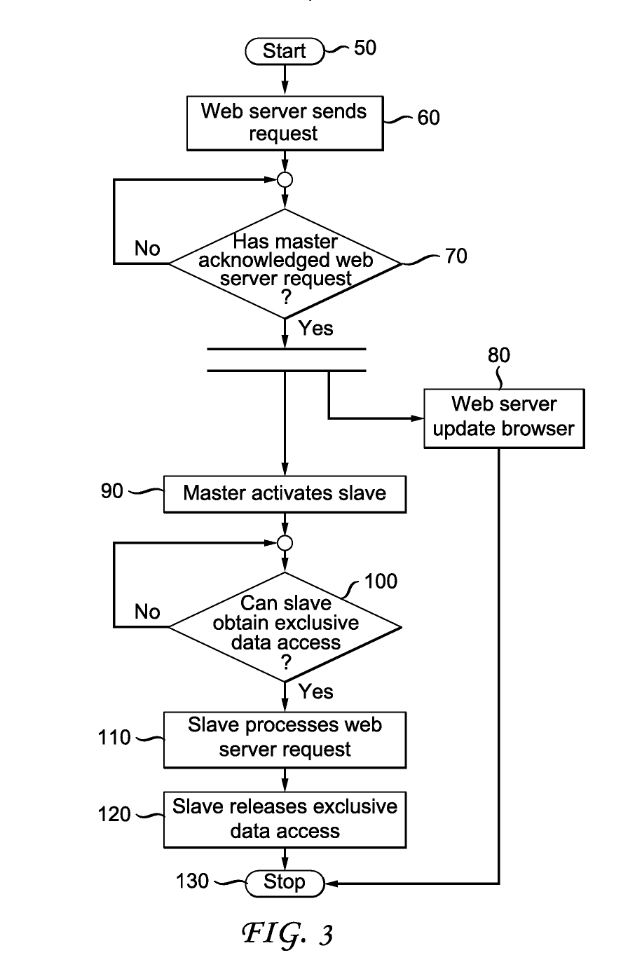

FIG. 3 is a flowchart illustrating a preferred method of QoS activation wherein the CPE is decoupled from the browser during browser update in accordance with the principles of the present invention. The method starts at 50, and at 60 a web server sends a request to initiate QoS activation. It is then determined at 70, whether a master has acknowledged the server request, and if not, then the method continues to inquire whether the master has acknowledged the request. If so, then at 80 the web server (typically remote from the CPE) updates the browser if the updates are available. The method then ends at 130.

Also at 90, the master activates the slave, and at 100, it is determined whether the slave can obtain exclusive data access to updates. If not, then the method repeats until the slave can obtain exclusive data access. Then at 110 the slave processes the web server request, and at 120 the slave releases the exclusive data access. The method stops at 130.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

The invention decouples the CPE system configuration web browser request from the actual CPE operation, thereby allowing instantaneous web browser updates and thus improving the user experience. The updating performed in accordance with the invention is “instantaneous” in the sense that it is performed without interfering with the other functions of the CPE. The term instantaneous as used herein is not meant to imply or mean that there is no time delay between the QoS request and the actual browser updating. This improves the QoS and improves the overall user experience. The inventive request and acknowledgment steps described herein also prevent race conditions between a web browser and CPE operations. The following code is an exemplary embodiment of implementation of the inventive methods and apparatus.

### Web Server Code Requests QoS Activation:

hdr.type = CMS_MSG_QOSQ_EVENT;
hdr.src = mdmLibCtx.eid;
hdr.dst = EID_TCH_APPS;
hdr.flags_event = 1;
hdr.wordData = QOSQ_ENABLE;
/* STEP 1: web server sends request and awaits acknowledgement

using BCM API */

ret = cmsMsg_sendAndGetReply(mdmLibCtx.msgHandle,
(const CmsMsgHeader *) &hdr);
/* STEP 2: web server received request acknowledgement and proceeds

with browser update */

### Master/Slave Management Code Services QoS Activation Request:

### Master Code:

```
CmsRet ServiceQos(void *msgHandle, CmsMsgHeader *msg)
{
  CmsRet ret = CMSRET_SUCCESS;
  pthread_attr_t attr;
  pthread_t tid;
  CmsMsgHeader *msgarg;
  if (msg−>type == CMS_MSG_QOSQ_EVENT &&
```

```
  (msg−>wordData == QOSQ_ENABLE ∥
  msg−>wordData == QOSQ_DISABLE ∥
  msg−>wordData == QOSQ_ADD_CLASSIFIER ∥
  msg−>wordData == QOSQ_REMOVE_CLASSIFIER))
```

{

/* STEP 3: management master code acknowledges request using

BCM API before servicing request */

if ((ret = cmsMsg_sendReply(msgHandle, (const CmsMsgHeader *)

msg, CMSRET_SUCCESS)) == CMSRET_SUCCESS)

```
{
  if ((msgarg = cmsMsg_duplicate((const CmsMsgHeader *)
  msg)))
  {
```

switch (pthread_attr_init(&attr))
{
case 0:

switch (pthread_attr_setdetachstate(&attr,

PTHREAD_CREATE_DETACHED))

```
{
  case 0:
  /* STEP 4: management master code launches slave code
```

thread that services request */

switch (pthread_create(&tid, (const pthread_attr_t *)

&attr, &ServiceQoS_thread, (void *) msgarg))

### Slave Code Thread:

```
static void *ServiceQoS_thread(void *arg)
{
  CmsRet ret = CMSRET_SUCCESS;
  CmsMsgHeader *msg = (CmsMsgHeader *) arg;
  char l3Ifname[CMS_IFNAME_LENGTH] = {0};
  cmsAst_assert(msg != (CmsMsgHeader *) 0);
  switch (pthread_detach(pthread_self( )))
  {
```

```
case 0:
  switch ((QosQ_Event_e) msg−>wordData)
  {
```

case QOSQ_ENABLE:
/* STEP 5: slave code thread awaits BCM Memory Data

Model lock using BCM API */

```
  if ((ret = cmsLck_acquireLock( )) == CMSRET_SUCCESS)
  {
```

/* STEP 6: slave code thread acquired BCM Memory Data

Model lock */

/* Get layer3 interface name */
if ((ret = dalRt_getActiveDefaultGateway(l3Ifname))

== CMSRET_SUCCESS)

```
{
  if (cmsUtl_strcmp(l3Ifname, “&nbsp”))
  {
```

/* STEP 7: slave code thread services request by

activating QoS */

ret = ActivateDefaultQos(app_msghandle( ), msg);

}
}
cmsLck_releaseLock( );

}
break;

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of updating software associated with customer premises equipment (CPE), comprising:
sending a request to resources external to the CPE for update data to update the software;
decoupling the CPE from the external resources so that the software can be updated without interfering with other functions of the CPE during updating of the software; and
updating the software as the CPE is decoupled from the external resources and recoupling the CPE to the external resources after updating of the software is completed.

2. The method of claim 1, wherein the software to be updated is a browser.

3. The method of claim 2, wherein the external resources provide browser updates to a system in which the CPE is located.

4. The method of claim 3, wherein the sending comprises activating a web server associated with the CPE and waiting for an acknowledgment to be received from the web server that the request has been received.

5. The method of claim 4, wherein the sending further comprises enabling a master/slave management module to perform the update.

6. The method of claim 5, wherein the sending further comprises acknowledging by the master of the master/slave management module that the update request has been sent.

7. The method of claim 6, wherein updating is performed by the slave of the master/slave module receiving the acquired update data activating the browser in accordance with the update.

8. The method of claim 7, further comprising recoupling the CPE to the web server to enable the updated browser to be used by the user after updating.

9. A customer premises equipment (CPE) having associated software which can be updated, comprising:
memory for storing the software that can be updated; and
a processor for operating on the software, wherein the processor is configured for sending a request to resources external to the CPE for update data to update the software, decoupling the CPE from the external resources so that the software can be updated without interfering with other functions of the CPE during updating of the software, and updating the software as the CPE is decoupled from the external resources and recoupling the CPE to the external resources after updating of the software is completed.

10. The CPE of claim 9, wherein the software to be updated is a browser.

11. The CPE of claim 10, wherein the external resources provide browser updates to a system in which the CPE is located.

12. The CPE of claim 11, wherein the sending comprises activating a web server associated with the CPE and waiting for an acknowledgement to be received from the web server that the request has been received.

13. The CPE of claim 12, wherein the sending further comprises enabling a master/slave management module to perform the update.

14. The CPE of claim 13, wherein the sending further comprises acknowledging by the master of the master/slave management module that the update request has been sent.

15. The CPE of claim 14, wherein updating is performed by the slave of the master/slave module receiving the acquired update data activating the browser in accordance with the update.

16. The CPE of claim 15, further comprising recoupling the CPE to the web server to enable the updated browser to be used by the user after updating.
